(19) United States
(12) Patent Application Publication
(10) Pub. No.: US 2026/0127279 A1
(43) Pub. Date: May 7, 2026

(54) INTRUSION DETECTION FOR MANAGEMENT SYSTEMS OF COMPUTER PLATFORMS

(71) Applicant: Intel Corporation, Santa Clara, CA (US)

(72) Inventors: Farah E. FARGO, Hudson, MA (US); Marko BARTSCHERER, Cornelius, OR (US); Olivier FRANZA, Brookline, MA (US); Sreenadh KARETI, Fremont, CA (US); Julien CARRENO, Glounthaune (IE); Jeremy C. SIADAL, Banks, OR (US); Hector A. BARAJAS VILLALOBOS, Portland, OR (US)

(21) Appl. No.: 19/425,530

(22) Filed: Dec. 18, 2025

(51) Int. Cl. G06F 21/55; G06F 21/53; G06F 21/56

(52) U.S. Cl. CPC G06F 21/554; G06F 21/53; G06F 21/566

(57) ABSTRACT

Examples described herein relate to a device bus to be coupled to one or more platforms and a management controller to monitor a first management controller process executed in a first virtualized execution environment and perform a corrective action based on identification of anomalies in operation of the first management controller process executed in the first virtualized execution environment. In some examples, the first management controller process executed in the first virtualized execution environment is to monitor and manage hardware and software of a corresponding platform of the one or more platforms.

In a data center, a hypervisor is a processor-executed software or firmware that creates and manages virtual machines (VMs) by allocating physical resources (e.g., processor resources, memory resources, network interface bandwidth) to the VMs. Cyber-attacks on the hypervisor can allow attacks on VMs. For example, vulnerabilities include Denial of Service (DoS) attacks where the operation of the VMs can be stopped and results in data loss. In addition, code execution can be compromised where a program execution flaw in the VM allows attackers to run malicious code inside the VMs. Other vulnerabilities include running extraneous services to burden the hardware resources and memory corruption.

### BRIEF DESCRIPTION OF THE DRAWINGS

FIG. 1 depicts an example system.

FIG. 2 depicts an example system.

FIG. 3 depicts an example operation of a policy engine.

FIG. 4 shows an example process.

FIG. 5 depicts a system.

### DETAILED DESCRIPTION

Various examples can attempt to reduce attacks on virtualized execution environments by executing management controller processes for platforms (e.g., central processing units (CPUs), graphics processing units (GPUs), accelerators, memory, and other circuitry) in virtualized execution environments and monitoring performance of the management controller processes in virtualized execution environments to detect anomalies in corresponding platforms. The management controller can execute a management controller introspection system to monitor the operating system, states, activities, and virtual resources of the management controller processes executing in virtualized execution environments. The management controller introspection system can detect attacks on management controllers in virtualized execution environments by detecting activities that violate operating parameters. Such activities that violate operating parameters can be due to intrusions in virtualized execution environments, which violate predefined security policies. Activities that violate operating parameters can include changes in states of at least: active processes, memory addresses accessed, processor utilization, firmware (FW) version, platform temperature, power consumption, etc. By machine learning (ML)-based allow listing, the management controller introspection system can monitor the management controllers in virtualized execution environments and perform anti-roll back to detect if firmware rolled back to a non-permitted version in a corresponding platform. The management controller introspection system can apply an allowlist based on a model that includes the possible accepted parameters so that the outliers can be considered as malicious. Based on detecting potentially malicious actions involving management controllers in virtualized execution environments, the management controller introspection system can perform an action to improve system resilience against attacks. Examples of actions include at least: moving management controller processes into another virtualized execution environment and shutdown the virtualized execution environment that is associated with anomalous operating states so that an attacker could lose its access to the virtualized execution environment, rollback the virtualized execution environment to a last known safe state, limit accesses and privileges of the virtualized execution environment (e.g., permit platform monitoring but not configuration (e.g., not permitting firmware updates or configuration change)), or send an alert to an orchestrator or data center administrator.

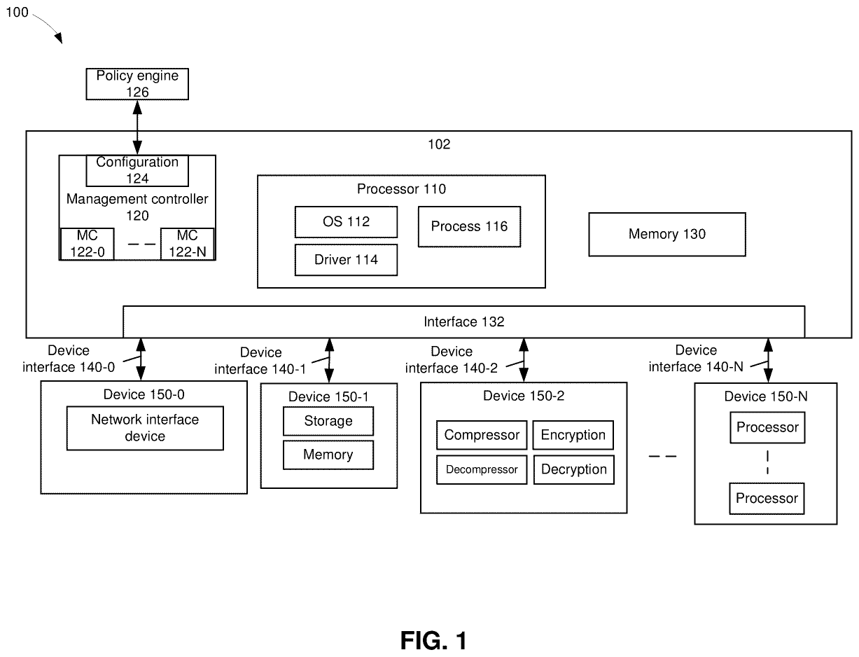

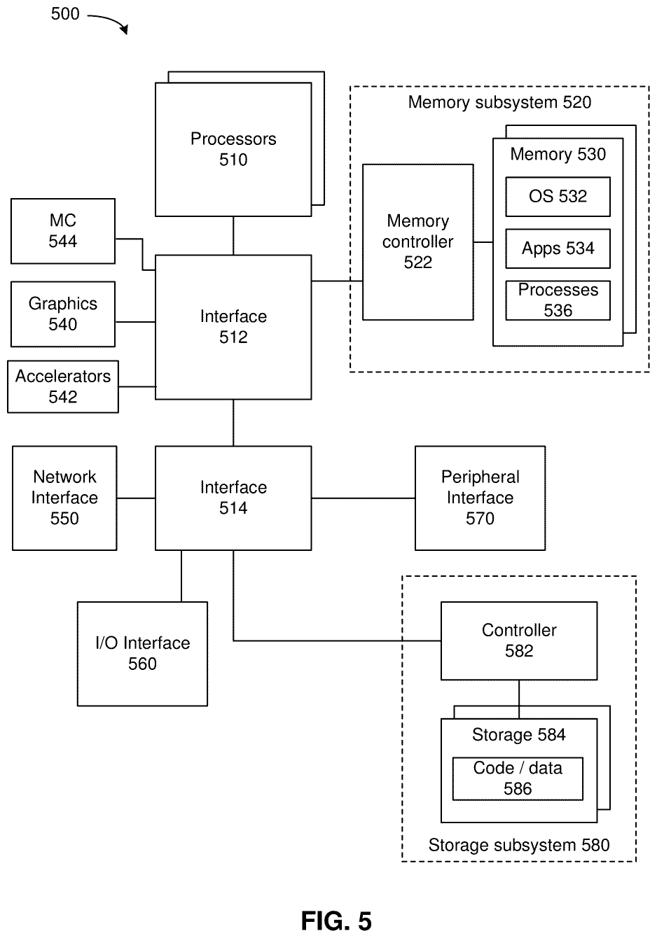

FIG. 1 depicts an example system. Host 100 can include one or more processors 110, memory 140, and other circuitry and software described at least with respect to FIG. 5. Processors 110 can execute at least one or more of: operating system (OS) 112, driver 114, processes 116, and other software. Processes 116 can include one or more of: an application, process, thread, a virtual machine (VM), microVM, container, microservice, virtual function (VF), virtual device, or other virtualized execution environment. Driver 114 can provide a communication interface between OS 112 and one or more devices 150-0 to 150-N, where N is an integer.

Processor 110 can access one or more of devices 150-0 to 150-N using interface 132 and device interfaces 140-0 to 140-N consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

One or more of devices 150-0 to 150-N can include one or more: accelerator, graphics processing unit (GPU), storage device, network interface device, or other circuitry. For example, an accelerator can perform cryptographic, compression, or decompression operations on data. Devices 150-0 to 150-N can include one or more hardware platforms that includes at least: a host interface board (e.g., instance of PCIe switches), cluster of processors (e.g., cores, GPUs, accelerators, or other circuitry), switch boards (e.g., network interface devices, Ethernet or NVLink network switches, or virtual network switches), or others.

Management controller (MC) 120 can include a processor configured to perform monitoring at least of device temperature, fan speeds, and power status of devices 150-0 to 150-N. Management controller 120 can be configured to respond to remote actions by performance of actions such as power cycling, booting, and resetting devices or circuitry. Management controller 120 can provide management capabilities independent of OS 112, through a dedicated management out of band (OOB) network port and can support protocols such as Intelligent Platform Management Interface (IPMI) and Redfish. OOB communications can use an independent communication channel from a network channel used for data or control packet transmissions. Management controller 120 can provide telemetry and crash data for troubleshooting and proactive maintenance. Management controller 120 can be used to automate the initial setup and firmware updates for servers. Firmware can include at least Basic Input/Output System (BIOS) or Unified Extensible Firmware Interface (UEFI). In some examples, management controller 120 can be implemented as one or more of: Baseboard Management Controller (BMC), Intel® Management or Manageability Engine (ME), or other devices.

As described herein, management controller 120 can execute a management hypervisor that executes management controllers (MCs) 122-0 to 122-N for respective hardware platforms 150-0 to 150-N. One or more management controllers 122-0 to 122-N for hardware platforms can perform remote management (e.g., power control, virtual media, Serial over LAN (SOL), and remote console access); hardware monitoring to tracks sensors, fans, temperatures, voltages, and events; perform power management such as controlling server power states (on/off/reset); provide remote access that enables out-of-band management via dedicated network for troubleshooting; perform event logging to record system events for diagnostics; manage firmware updates; or others.

In some examples, one or more management controllers for hardware platforms 122-0 to 122-N can be executed in virtualized execution environments. One or more management controllers for hardware platforms 122-0 to 122-N can be implemented in accordance with a OpenBMC Linux distribution. A virtualized execution environment (VEE) can include at least a virtual machine, microVM, a container, or a microservice.

Based on configuration 124 (e.g., allow list) from policy engine 126, management controller 120 can monitor states of one or more management controllers for hardware platforms 122-0 to 122-N to identify anomalies and based on identifying anomalies, perform corrective actions. A range of permitted states of one or more management controllers for hardware platforms 122-0 to 122-N can include at least one or more of: virtualized execution environment name, virtualized execution environment identifiers (IDs), operating system types (e.g., Linux, Zephyr, NetBSD, Android, Cisco Internetwork Operating System (IOS), or other real time operating systems), active process list (e.g., processes that are active in a virtualized execution environment), virtualized execution environment memory operations and cache (e.g., amount of memory or cache allocated to virtualized execution environment, memory bandwidth), virtual CPU (vCPU) register information (e.g., utilization, register contents), virtual GPU (vGPU) register information (e.g., utilization, register contents), open ports (e.g., active network port numbers, active PCIe root ports, state of connection between host and device, range of Transaction Layer Packet (TLP) traffic), permitted firmware (FW) versions, etc.

Corrective actions can include moving management controller process to another VM and shutdown the affected VM so the attacker would lose its access to the VM, reduce privileges of the affected VM to permit monitoring but not software or firmware modification of a corresponding platform, rolling back the affected VM to a previous snapshot in which operating parameters are within an accepted range of states, notifying a data center administrator of an intrusion, or others.

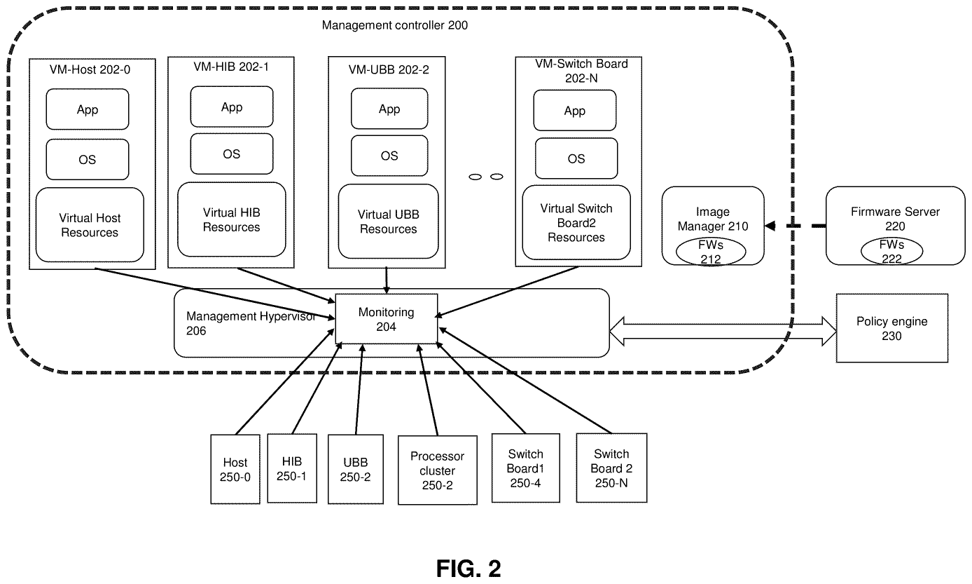

FIG. 2 depicts an example system. Management controller 200 can monitor and manage at least hardware and software of platforms 250-0 to 250-N, where N is an integer. For example, management controller 200 can manage loading firmware updates 212 to platforms 250-0 to 250-N based on firmware 222 received from firmware server 220. Management hypervisor 206 can create virtualized execution environments from templates with operating systems to reduce a likelihood of intrusions, malwares, or any malicious activities. A virtualized execution environment can run a guest operating system (OS) and a set of applications such as management controller processes. Management controller processes can execute in respective virtualized execution environments (e.g., virtual machines (VMs) or others) 202-0 to 202-N and monitor and manage activities of respective platforms 250-0 to 250-N. Management controller processes executing in virtualized execution environments 202-0 to 202-N can perform management controller operations for associated platforms 250-0 to 250-N.

For example, management controller processes executing in virtualized execution environments 202-0 to 202-N can include an instance of host management controller software; host interface board management controller software that manages PCIe switches; universal base board (UBB) management controller software that manages a backplane for connecting GPUs and accelerators; processor cluster management controller software that manages a system of processors (e.g., cores, GPUs, accelerators, or others); switch board management controller software that manages virtual or physical device switches; or others.

Management controller 200 can perform monitoring 204 of management controller processes executing in virtualized execution environments 202-0 to 202-N and identify states of management controller processes executing in virtualized execution environments 202-0 to 202-N that are outside of a range of accepted states. For example, policy engine 230 can monitor state data that is historic and time bounded for management controller processes 202-0 to 202-N to determine a range of accepted states. Monitoring 204 can monitor operating system (OS) and application (e.g., management controller processes), virtual resources (e.g., allocated device interface resources, allocated memory resources, allocated processor resources, or others), or others. For example, for host 250-0, virtual host resources can represent device resources allocated to a virtualized execution environment that executes a management controller process for host 250-0. For example, for host interface bus 250-1, virtual host resources can represent device resources allocated to a virtualized execution environment that executes a management controller process for host interface bus 250-1. For example, for universal base board (UBB) 250-2, virtual host resources can represent device resources allocated to a virtualized execution environment that executes a management controller process for universal base board (UBB) 250-2. For example, for processor cluster 250-3, virtual host resources can represent device resources allocated to a virtualized execution environment that executes a management controller process for processor cluster 250-3. For example, for switch board 250-4, virtual host resources can represent device resources allocated to a virtualized execution environment that executes a management controller process for switch board 250-4.

Based on detection of an operating state that is outside of a permitted range, hypervisor 206 can perform a corrective action such as moving management controller operations from a first virtualized execution environment to a second virtualized execution environment and shutdown the first virtualized execution environment so the attacker may lose its access to the first virtualized execution environment. Other corrective actions can include reduce privileges of the affected virtualized execution environment to permit monitoring but not software or firmware modification of a corresponding platform, rolling back the affected virtualized execution environment to a previous snapshot in which operating parameters are within an accepted range of states, notifying a data center administrator of an intrusion, or others. In some examples, hypervisor 206 can be implemented as part of Kernel-based Virtual Machine (KVM), Libvirt, XEN hypervisors, or others.

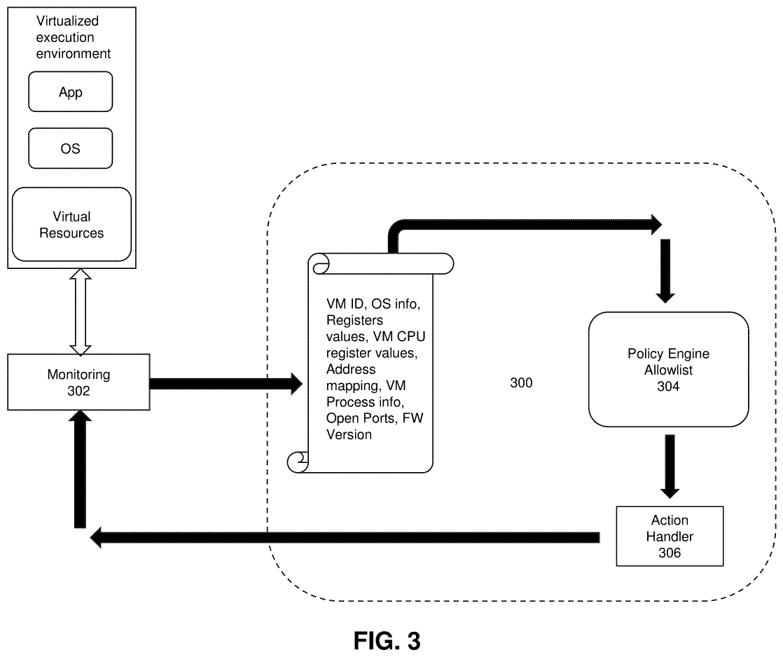

FIG. 3 depicts a policy engine that can determine states of platform management controller processes to detect malicious activity and form and adjust an allow list. Policy engine 300 can determine states of platform management controller processes executing in virtualized execution environments during a training phase and runtime phase. For the training phase, policy engine 300 can monitor platform management controller processes to identify a range of states associated with no intrusion or maliciousness. Policy engine 300 can configure a monitoring process 300 of a management controller with allow list 304, which can identify a range of states associated with no intrusion or maliciousness. Allowlist 304 can indicate a range of accepted virtualized execution environment names, virtualized execution environment identifiers (IDs), operating system types (e.g., Linux, Zephyr, NetBSD, Android, Cisco Internetwork Operating System (IOS), or other real time operating systems), active processes (e.g., processes that are active in a virtualized execution environment), amount of memory or cache allocated to virtualized execution environment, memory bandwidth, virtual CPU (vCPU) register information (e.g., utilization, register contents), virtual GPU (vGPU) register information (e.g., utilization, register contents), open ports (e.g., active network port numbers, active PCIe root ports, state of connection between host and device, normal level Transaction Layer Packet (TLP) traffic), permitted firmware (FW) versions, etc.

For a runtime phase, policy engine 300 can modify allowlist 304 based on determined states. For example, when there is a request for an out of band (OOB) firmware update, allow list 304 can be updated with the new FW version so it becomes part of a range of accepted firmware versions.

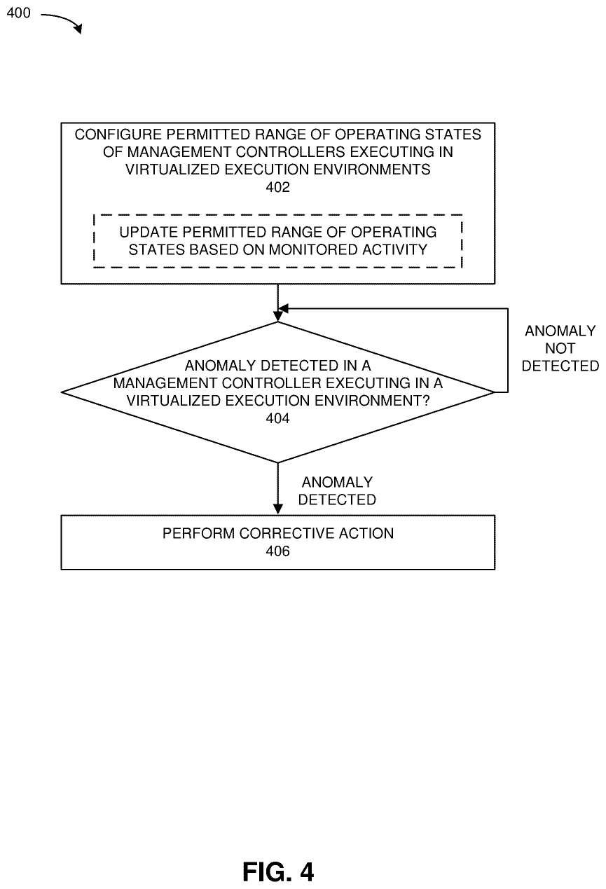

FIG. 4 depicts an example process. The process can be performed by a management controller or policy engine. At 402, a range of permitted states of management controller processes executing in virtualized execution environments can be determined based on operating states of management controller processes executing in virtualized execution environments. The range of permitted states can include a range of permitted states of management controller processes executing in virtualized execution environments. The management controller processes executing in virtualized execution environments can perform management and monitoring operations for associated platforms, such as host platforms, host interface bus platforms, universal base board (UBB) platforms; a processor cluster platform; device switch board; or others.

At 404, the management controller can be configured to detect anomalies in management controller processes executing in virtualized execution environments based on the range of permitted states.

At 406, based on detection of anomalies in a management controller processes executing in virtualized execution environments, at 408, a corrective action can be performed on a management controller process executing in a virtualized execution environment. A corrective action can include migrating the management controller process to another virtualized execution environment, instantiate another management controller process to execute in a virtualized execution environment and stop operations of the management controller process executing in the virtualized execution environment, limit activities of the management controller process, restrict resources allocated to the management controller process executing in the virtualized execution environment, or others.

FIG. 5 depicts a system. The system can use examples described herein to monitor operations of platform management controllers executing in virtualized execution environments and perform remedial actions based on monitored anomalies. In some examples, a device can perform rate limiting of performance of requests as well. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Management controller 544 can perform management and monitoring capabilities for system administrators or orchestrators to manage and monitor operation of circuitry, firmware, and software of system 500. As described herein, management controller 544 can detect operating states of management controller processes executing in virtualized execution environments for platforms coupled to interface 512 or interface 514 and perform remedial or corrective actions for a management controller process executing in a virtualized execution environment with an operating state that is outside of a permitted range.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: a device bus to be coupled to one or more platforms and a management controller to monitor a first management controller process executed in a first virtualized execution environment and perform a corrective action based on identification of anomalies in operation of the first management controller process executed in the first virtualized execution environment, wherein: the first management controller process executed in the first virtualized execution environment is to monitor and manage hardware and software of a corresponding platform of the one or more platforms.

Example 2 includes one or more earlier or later examples, wherein: the management controller comprises circuitry to perform monitoring and configuration of the one or more platforms.

Example 3 includes one or more earlier or later examples, wherein: the identification of anomalies in operation of the first management controller process executed in the first virtualized execution environment is based on changes in state of the first management controller process executed in the first virtualized execution environment.

Example 4 includes one or more earlier or later examples, wherein: the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

Example 5 includes one or more earlier or later examples, wherein: the device bus is to operate consistent with Peripheral Component Interconnect express (PCIe).

Example 6 includes one or more earlier or later examples, wherein: the one or more platforms coupled to the device bus comprise at least: a host system platform, a host interface bus platform, a processor cluster platform, or a switch platform.

Example 7 includes one or more earlier or later examples, wherein: the corrective action comprises one or more of: migration of operations of the first management controller process executed in the first virtualized execution environment to a second virtualized execution environment and shutting down the first virtualized execution environment, restrict activities of the first management controller process, or reduce resources allocated to the first management controller process.

Example 8 includes one or more earlier or later examples, and includes at least one non-transitory computer-readable medium comprising instructions stored thereon, that if executed by one or more processors, cause the one or more processors to: configure a management controller to monitor a management controller process executed in a virtualized execution environment, wherein the management controller process executed in the virtualized execution environment is to monitor and manage hardware and software of a corresponding platform and configure the management controller to perform a corrective action based on identification of anomalies in operation of the management controller process executed in the virtualized execution environment.

Example 9 includes one or more earlier or later examples, wherein: the management controller comprises circuitry to perform monitoring and configuration of the platforms.

Example 10 includes one or more earlier or later examples, wherein the identification of anomalies in operation of the management controller process is based on changes in state of the management controller process.

Example 11 includes one or more earlier or later examples, wherein the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

Example 12 includes one or more earlier or later examples, wherein the platform comprises at least: a host system platform, a host interface bus platform, a processor cluster platform, or a switch platform.

Example 13 includes one or more earlier or later examples, wherein the corrective action comprises migrating operations of the management controller process to a second virtualized execution environment and shutting down the virtualized execution environment, restrict activities of the management controller process, or reduce resources allocated to the management controller process.

Example 14 includes one or more earlier or later examples, and includes instructions stored thereon, that if executed by one or more processors, cause the one or more processors to: configure the management controller to adjust the anomalies in operation of the management controller process executed in the virtualized execution environment.

Example 15 includes one or more earlier or later examples, and includes a method comprising: monitoring, by a management controller, management controller processes in virtualized execution environments for one or more platforms and performing a corrective action, by the management controller, based on identification of anomalies in operation of at least one of the management controller processes executed in virtualized execution environments.

Example 16 includes one or more earlier or later examples, wherein: the management controller performs out of band monitoring and configuration of the one or more platforms.

Example 17 includes one or more earlier or later examples, wherein the identification of anomalies in operation of at least one of the management controller processes is based on changes in state of the at least one of the management controller processes.

Example 18 includes one or more earlier or later examples, wherein the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

Example 19 includes one or more earlier or later examples, wherein the one or more platforms comprise: a host system, a host interface bus, a processor cluster, or a switch.

Example 20 includes one or more earlier examples, and includes adjusting a configuration of the anomalies based on runtime activities of the management controller processes in virtualized execution environments for the one or more platforms.

1. An apparatus comprising:
a device bus to be coupled to one or more platforms and
a management controller to monitor a first management controller process executed in a first virtualized execution environment and
perform a corrective action based on identification of anomalies in operation of the first management controller process executed in the first virtualized execution environment, wherein:
the first management controller process executed in the first virtualized execution environment is to monitor and manage hardware and software of a corresponding platform of the one or more platforms.

2. The apparatus of claim 1, wherein:
the management controller comprises circuitry to perform monitoring and configuration of the one or more platforms.

3. The apparatus of claim 1, wherein the identification of anomalies in operation of the first management controller process executed in the first virtualized execution environment is based on changes in state of the first management controller process executed in the first virtualized execution environment.

4. The apparatus of claim 3, wherein the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

5. The apparatus of claim 1, wherein the device bus is to operate consistent with Peripheral Component Interconnect express (PCIe).

6. The apparatus of claim 1, wherein the one or more platforms coupled to the device bus comprise at least: a host system platform, a host interface bus platform, a processor cluster platform, or a switch platform.

7. The apparatus of claim 1, wherein the corrective action comprises one or more of: migration of operations of the first management controller process executed in the first virtualized execution environment to a second virtualized execution environment and shutting down the first virtualized execution environment, restrict activities of the first management controller process, or reduce resources allocated to the first management controller process.

8. At least one non-transitory computer-readable medium comprising instructions stored thereon, that if executed by one or more processors, cause the one or more processors to:
configure a management controller to monitor a management controller process executed in a virtualized execution environment, wherein the management controller process executed in the virtualized execution environment is to monitor and manage hardware and software of a corresponding platform and
configure the management controller to perform a corrective action based on identification of anomalies in operation of the management controller process executed in the virtualized execution environment.

9. The non-transitory computer-readable medium of claim 8, wherein:
the management controller comprises circuitry to perform monitoring and configuration of the platforms.

10. The non-transitory computer-readable medium of claim 8, wherein the identification of anomalies in operation of the management controller process is based on changes in state of the management controller process.

11. The non-transitory computer-readable medium of claim 10, wherein the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

12. The non-transitory computer-readable medium of claim 8, wherein the platform comprises at least: a host system platform, a host interface bus platform, a processor cluster platform, or a switch platform.

13. The non-transitory computer-readable medium of claim 8, wherein the corrective action comprises migrating operations of the management controller process to a second virtualized execution environment and shutting down the virtualized execution environment, restrict activities of the management controller process, or reduce resources allocated to the management controller process.

14. The non-transitory computer-readable medium of claim 8, comprising instructions stored thereon, that if executed by one or more processors, cause the one or more processors to:
configure the management controller to adjust the anomalies in operation of the management controller process executed in the virtualized execution environment.

15. A method comprising:
monitoring, by a management controller, management controller processes in virtualized execution environments for one or more platforms and
performing a corrective action, by the management controller, based on identification of anomalies in operation of at least one of the management controller processes executed in virtualized execution environments.

16. The method of claim 15, wherein:
the management controller performs out of band monitoring and configuration of the one or more platforms.

17. The method of claim 15, wherein the identification of anomalies in operation of at least one of the management controller processes is based on changes in state of the at least one of the management controller processes.

18. The method of claim 15, wherein the state comprises one or more of: permitted virtualized execution environment name, permitted virtualized execution environment identifier (ID), operating system type, permitted active processes, permitted memory operations, permitted processor register information, permitted open ports, permitted port activity, or permitted firmware version.

19. The method of claim 15, wherein the one or more platforms comprise: a host system, a host interface bus, a processor cluster, or a switch.

20. The method of claim 15, comprising:
adjusting a configuration of the anomalies based on runtime activities of the management controller processes in virtualized execution environments for the one or more platforms.
